(19) United States
(12) Patent Application Publication
(10) Pub. No.: US 2018/0251380 A1
(43) Pub. Date: Sep. 6, 2018

(54) METHOD FOR PRODUCING BORAZANE

(71) Applicant: ARIANEGROUP SAS, Paris (FR)

(72) Inventors: Nicolas VANDECANDELAERE, Champcueil (FR); Sébastien COMTE, Savigny le Temple (FR)

(73) Assignee: ARIANEGROUP SAS, Paris (FR)

(21) Appl. No.: 15/759,944

(22) PCT Filed: Sep. 16, 2016
(86) PCT No.: PCT/FR2016/052349

§ 371 Date: Mar. 14, 2018

(30) Foreign Application Priority Data
Sep. 18, 2015 (FR) 1558803

(51) Int. Cl. C01B 35/14

(52) U.S. Cl. CPC C01B 35/146

(57) ABSTRACT

A method for producing borazane, includes the synthesis of the borazane by reacting (metathesis reaction) at least one ammonium salt with at least one borohydride, the at least one borohydride being selected from the alkali metal borohydrides and the alkali-earth metal borohydrides. The (metathesis) reaction is carried out with gaseous ammonia flushing; gaseous ammonia being co-liquefied with the at least one borohydride and gradually with borazane as the borazane is synthesized.

The present invention relates to a method for producing borazane or ammonia borane of chemical formula NH₃BH₃. This method is particularly advantageous.

The production of borazane is a key for the success of programs for generating hydrogen from solid compounds. This generation of hydrogen from solid compounds is currently one of the means proposed for feeding fuel cells. In this context, the use of borazane (or ammonia borane) as solid precursor for hydrogen production is already known.

In point of fact, the borazane or ammonia borane complex, of chemical formula NH₃BH₃, which exists in the form of a white crystalline powder, has the unique potential of containing 19.6 wt. % of hydrogen. It is thus positioned as a particularly advantageous candidate for the solid storage of hydrogen.

However, to the inventors' knowledge, a method for producing borazane that is suitable for its manufacture on an industrial scale has hitherto not been proposed. Various approaches have, however, been studied, or even developed. One route for synthesizing borazane based on a movement between a borane (R.BH₃) and an amine, typically ammonia, has been widely described, especially by X. Chen et al. in Chem. Eur. J., 2012, 18, 11994-11999.

The route for synthesizing borazane that is the most common and the best developed to date is that based on a metathesis reaction (of salts): the reaction of at least one ammonium salt (generally chosen from ammonium chloride, ammonium sulfate, ammonium carbonate, ammonium formate, and mixtures thereof) with at least one alkali metal and/or alkaline-earth metal borohydride (generally chosen from lithium borohydride, sodium borohydride and mixtures thereof), in a solvent, preferably tetrahydrofuran (THF). This synthesis route has been widely and for a long time (see S. G. Shore and R. W. Parry, J. Am. Chem. Soc., 1955, 77, pages 6084-6085) described in the literature (see also A. K. Figen et al., Int. J. Hydrogen Energ., 38 (2013), 16215-16228). The reaction is generally performed between such an ammonium salt and such a borohydride. The method most commonly used consists in reacting ammonium carbonate (NH₄)₂CO₃ with sodium borohydride NaBH₄, in THF. The reaction under consideration is represented schematically below:

THF

2Na BH₄+(NH₄)₂CO₃→Na₂CO₃ (co-product)+2NH₃BH₃ (borazane)+2H₂ (gas).

The NH₃BH₃ formed is soluble in said THF. It is separated from the sodium carbonate (co-product) also formed, which precipitates out. In point of fact, at the end of the reaction, the THF solution (thus containing the NH₃BH₃ in solution) is filtered to remove the majority of the solid materials in suspension therefrom. The THF solvent is then evaporated off. A powder is finally recovered, which essentially contains the desired complex (ammonia borane). These conventional methods for synthesizing borazane thus require the use of a solvent, THF or equivalent, which poses a real problem, in terms of risks to human health and to the environment. These risks are obviously exacerbated in a context of industrial-scale exploitation. Moreover, said solvent must be very anhydrous, so as to prevent the production of by-products, most particularly the production of boron oxides. In any event, the metathesis reaction is performed in relatively non-concentrated media, due to the relatively low solubility of the reagents in the solvent (THF type). This is a real obstacle to obtaining substantial synthesis productivities (synthesis productivity=amount of borazane produced per amount of solvent used for the synthesis operation).

Variants to the conventional methods based on a metathesis reaction performed in THF or equivalent have been proposed; said variants using liquid ammonia as co-solvent or as solvent. According to the teaching of patent application US 2010/272623 (see most particularly example 2 thereof), the reaction between sodium borohydride and ammonium chloride is performed in a liquid ammonia/THF mixture (solvent). According to the teaching of the publication, entitled “Ammonia-mediated, large-scale synthesis of ammonia borane” in DALTON TRANSITIONS, 2014, vol. 43, pages 16580-16583, the reaction between sodium borohydride and ammonium sulfate is performed in THF in the presence of liquid ammonia (5%). According to the teaching of patent U.S. Pat. No. 7,897,129, liquid ammonia is used as solvent. The use of liquid ammonia decidedly emburdens the implementation of the methods under consideration, a person skilled in the art being well aware that in order to have ammonia in liquid form, it is necessary to work at low temperature (below −33° C.) or under pressure (7-8 bar).

In such a context, the inventors have now, to their credit, proposed a novel implementation for the synthesis of borazane based on a metathesis reaction (reaction of at least one borohydride chosen from alkali metal borohydrides and alkaline-earth metal borohydrides with at least one ammonium salt). Said implementation, which is novel and particularly advantageous (see below), is based on the phenomenon hereinbelow, visualized by the inventors: the liquefaction of borohydrides (reactive solids of the metathesis reaction, as identified above) and that of (solid) borazane in the presence of gaseous ammonia (the liquefaction of said borohydrides and of said borazane with said gaseous ammonia), especially at a temperature and a pressure that are nothing like the temperature or pressure required for working with liquid ammonia (see above). The method should more correctly be referred to as a co-liquefaction of the (solid) borohydrides and of (gaseous) ammonia as well as a co-liquefaction of (solid) borazane and of (gaseous) ammonia. Physicochemical interactions, similar to those which develop during the dissolution of borazane in liquid ammonia (at a temperature of less than or equal to −33° C. or at a pressure of greater than or equal to 7-8 bar; a person skilled in the art knows the liquid-vapor diagram of ammonia), quite probably explain these co-liquefactions.

These co-liquefactions:
of the (solid) borohydrides and of gaseous ammonia, on the one hand, and
of (solid) borazane and of gaseous ammonia, on the other hand,
   were thus observed by the inventors: a liquid phase is generated by bringing at least one borohydride (as identified above) into contact with gaseous ammonia (the inventors have especially observed that a stream of gaseous ammonia, at a very low flow rate, directed onto 2 g of NaBH₄ powder caused deliquescence of the powder and then its liquefaction (0.7 g of gaseous ammonia then having been consumed)) and, in the same manner, a liquid phase is generated by bringing borazane into contact with gaseous ammonia (the inventors similarly observed that a stream of gaseous ammonia, at a very low flow rate, directed onto 2 g of NH₃BH₃ powder caused deliquescence of the powder and then its liquefaction (0.7 g of gaseous ammonia then having been consumed)).

During the implementation according to the invention of the metathesis reaction, these co-liquefactions proceed “successively”, such that the at least one borohydride reagent is co-liquefied (with gaseous ammonia) and the borazane formed (gradually as it is formed) is also co-liquefied (with the gaseous ammonia) (see the example below).

The co-liquefactions under consideration are selective insofar as the ammonium salts (other reactive solids of the metathesis reaction) do not become liquefied in the presence of gaseous ammonia (the inventors confirmed this fact by especially proceeding as specified above with 2 g of (NH₄)₂CO₃ etc., and also 2 g of Na₂CO₃ (co-product)).

These co-liquefaction phenomena and the exploitation of said phenomena in the context of a method for producing borazane based on a metathesis reaction are thus particularly advantageous in that they dispense with all the burdensome operating conditions for the liquefaction of ammonia and also make it possible to work without using any organic solvent (see below).

The subject of the present invention is a method for producing borazane, comprising the synthesis of said borazane by reaction of at least one ammonium salt with at least one borohydride, said at least one borohydride being chosen from alkali metal borohydrides and alkaline-earth metal borohydrides. In this, said method is based on a metathesis reaction.

Characteristically, said (metathesis) reaction is performed while flushing with (a flow of) gaseous ammonia (=under a permanent atmosphere of gaseous ammonia); gaseous ammonia being co-liquefied with said at least one borohydride and gradually with borazane as said borazane is synthesized.

In the context of performing a metathesis reaction, the presence of gaseous ammonia—permanent presence, due to the flushing, obtained without placing the reaction volume under pressure and which makes it possible to obtain high metathesis reaction yields (see the 70% of the example)—is entirely novel.

Said gaseous ammonia ensures the liquefaction of the at least one borohydride (solid reagent) (by co-liquefaction with said at least one borohydride) . . . and then that of the borazane synthesized (by co-liquefaction with said synthesized borazane).

It may already be noted here that, according to one variant (variant A: see below), the gaseous ammonia may be brought into contact (placed in contact) with a mixture of at least one borohydride and of at least one ammonium salt made beforehand and that, according to another variant (variant B: see below), it may be brought into contact (placed in contact) with at least one borohydride, the at least one ammonium salt then being added to the resulting liquid (resulting from the co-liquefaction).

The reaction proceeds in a heterogeneous medium (solid/liquid), which has a high content of solids (solids=initially the at least one ammonium salt and then increasingly less of said salt which is consumed and increasingly more of the co-product(s) generated). As said reaction (metathesis reaction) proceeds, the liquid phase of the reaction medium becomes depleted in the at least one borohydride (co-liquefied) which is consumed and becomes enriched in borazane which is synthesized and co-liquefied (while the solid phase of said reaction medium thus becomes depleted in said at least one ammonium salt and thus becomes enriched in the reaction co-product(s)).

It is proposed to successively schematically represent below variants A and B above of implementation of the metathesis reaction of the method of the invention in the case where the at least one ammonium salt consists of ammonium carbonate ((NH₄)₂CO₃) and where the at least one borohydride consists of sodium borohydride (NaBH₄).

Variant A of implementation of the metathesis reaction of the method of the invention may thus be schematically represented as follows:

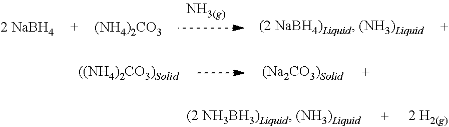

Variant B for implementing the metathesis reaction of the method of the invention may thus be represented schematically as follows:

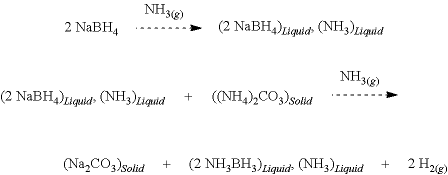

Taking the above reaction schemes into consideration, it is realized that the gaseous ammonia does not participate in the metathesis reaction performed according to the invention, It participates only in solid/gas co-liquefaction “reactions”.

A person skilled in the art already understands the great value of the method of the invention comprising the synthesis of borazane (metathesis reaction) performed while flushing with gaseous ammonia. It is thus not necessary, for this synthesis, to work under pressure or at low temperature. This synthesis may indeed be performed at atmospheric pressure and at room temperature (i.e. at a temperature (T) of between 18 and 25° C. (18° C.≤T≤25° C.)). Specifically, an implementation is more generally envisaged:
at a pressure (p) of between 1×10⁵ Pa and 2×10⁵ Pa (1 atm≤p≤2 atm) (it cannot be totally excluded from the context of the invention to perform the reaction under a low pressure (especially to accelerate the reaction)), advantageously at atmospheric pressure, and
at a temperature (T) of between −5° C. and 25° C. (−5° C.≤T≤25° C.) (due to exothermicity of the reaction, it may be appropriate to perform the reaction below room temperature).

Emphasis must also be placed on the fact that the implementation, according to the invention, of the metathesis reaction under a (permanent) atmosphere of gaseous ammonia dispenses with the use of any organic solvent (for instance THF (see above)). This is particularly advantageous with reference to said implementation of the reaction (without using solvent), but also to the subsequent recovery of the synthesized borazane (without solvent to be removed). Thus, the method of the invention is generally (in principle always) performed in the absence of organic solvent. However, the participation of such an organic solvent cannot be entirely excluded from the context of the invention.

Gaseous ammonia is advantageously used in a gaseous ammonia/at least one borohydride mole ratio of greater than 1. It is strongly recommended to use an excess of ammonia. In point of fact, gaseous ammonia is advantageously used in a mole ratio of greater than 5.

As indicated above, the (metathesis) reaction is performed while flushing with gaseous ammonia so as to be permanently, to the end of the reaction, under an atmosphere of gaseous ammonia (and to do so without the participation, at the start, of gaseous ammonia in overpressure).

Advantageously, for the synthesis, the at least one ammonium salt is used in excess (relative to the stoichiometry). Specifically, it is advantageous to deplete the at least one borohydride reacted with said at least one ammonium salt (the reaction being performed with the at least one ammonium salt in excess and conducted until it is complete (i.e. up to depletion of the at least one borohydride)), insofar as it is obviously advantageous, on conclusion of the reaction, to recover borane synthesized as selectively as possible (and with the highest possible yield). Specifically, it is easier to separate synthesized (co-liquefied) borane from a remainder of ammonium salt and from the reaction co-product(s) (solids) than synthesized (co-liquefied) borazane from a remainder of (co-liquefied) borohydride. It is easily understood that the excess under consideration (of the at least one ammonium salt relative to the stoichiometry) does not at all need to be large insofar as (it participates only to ensure the maximum possible consumption of the at least one borohydride present and insofar as) it must be removed thereafter. A small excess is advantageously recommended. It may be indicated, in a nonlimiting manner, that the excess (the small excess) under consideration is advantageously less than 1%.

As indicated above, the gaseous ammonia, for the purposes of co-liquefaction with the at least one borohydride, may be brought into contact with said at least one borohydride before (variant B) or after (variant A) mixing of the latter with the at least one ammonium salt.

According to one variant (variant A above), the method of the invention thus comprises (for the synthesis of borazane):
making a mixture of at least one ammonium salt with at least one borohydride (borohydride as specified above) (generally of an ammonium salt with such a borohydride);
flushing with gaseous ammonia to bring said mixture into contact with gaseous ammonia; gaseous ammonia then being co-liquefied with said at least one borohydride; and
reacting said at least one co-liquefied borohydride and said at least one ammonium salt under an atmosphere of gaseous ammonia; the synthesized borazane being co-liquefied with gaseous ammonia gradually as it is synthesized.

According to another variant (variant B above), the method of the invention thus comprises (for the synthesis of borazane):
flushing with gaseous ammonia to bring at least one borohydride (borohydride as specified above) (generally a borohydride) into contact with gaseous ammonia; gaseous ammonia being co-liquefied with said at least one borohydride;
adding, to said at least one borohydride co-liquefied with gaseous ammonia, at least one ammonium salt (generally one ammonium salt); and
reacting said at least one co-liquefied borohydride and said at least one ammonium salt, under an atmosphere of gaseous ammonia; the synthesized borazane being co-liquefied with gaseous ammonia gradually as it is synthesized.

Variant A is preferred insofar as the preliminary making of the mixture of solid reagents is opportune for performing the (metathesis) reaction.

With reference to the nature of the reagents under consideration, the following may be specified. The at least one ammonium salt is generally selected from ammonium carbonate, ammonium bicarbonate, ammonium sulfate, ammonium chloride, ammonium fluoride, ammonium nitrate, ammonium acetate, ammonium formate, and advantageously consists of ammonium carbonate; and/or, preferably and, said at least one borohydride is generally chosen from sodium borohydride, lithium borohydride and potassium borohydride and advantageously consists of sodium borohydride.

According to an advantageous variant, the method of the invention thus comprises the (metathesis) reaction between said ammonium carbonate and said sodium borohydride co-liquefied with gaseous ammonia.

The reagents used to perform the metathesis are advantageously conventionally used in powder form. Thus, according to variant A specified above, a pulverulent mixture of at least one ammonium salt with at least one borohydride is prepared and gaseous ammonia is brought into contact with this pulverulent mixture (by flushing) for the borohydride(s)/gaseous ammonia co-liquefaction.

It has been seen above:

that the synthesized borazane is, gradually as it is synthesized, co-liquefied with gaseous ammonia; and
that gradually as the synthesis proceeds, the liquid phase of the medium becomes depleted in co-liquefied borohydride(s) and becomes enriched in synthesized (also co-liquefied) borazane, whereas the solid phase of said reaction medium becomes depleted in ammonium salt(s) and thus becomes enriched in the reaction co-product(s).

We now come to the recovery of the synthesized borazane, said synthesized borazane being, in the context of the implementation of the method of the invention, co-liquefied with liquid ammonia.

The recovery of the synthesized borazane, from the reaction medium (mainly containing said synthesized borazane and the co-product(s) (synthesized in parallel), which may also contain a remainder of the at least one ammonium salt (reagent(s)) and/or a remainder of the at least one borohydride (other reagent(s)), impurities contained in the reagents and impurities resulting from spurious reactions) is an operation that should very advantageously be performed on a reaction medium no longer containing borohydride(s) (in any event liable to contain only a minimum amount thereof). A person skilled in the art understands that the borazane recovered is advantageously recovered as pure as possible and appreciates the difficulty in separating said synthesized borazane from any borohydride. The implementation of the borazane synthesis according to the invention (metathesis while flushing with gaseous ammonium) under conditions which minimize, in the final analysis, the presence of borohydride(s), is thus greatly favored, i.e. it is preferred to perform the reaction to its completion and with, at the start, an excess (advantageously a slight excess) of the at least one ammonium salt relative to the stoichiometry. The depletion of borohydride(s) from the reaction medium may be monitored by analysis of withdrawn samples, especially by ¹H NMR.

Under these conditions, for the recovery of the synthesized borazane, it is possible, according to a first variant, to work directly on the reaction medium. Thus, on conclusion of the synthesis (=on completion of said synthesis; any feed of gaseous ammonia obviously being stopped (i.e. the flushing with gaseous ammonia being stopped)), started with an excess of the at least one ammonium salt, 1) the ammonia is removed (first the ammonia present in the gaseous headspace, and then the ammonia present in the liquid phase (which transits via the headspace)) (by evaporation, advantageously by evaporation under vacuum, with reference to the kinetics); said ammonia removal causing the precipitation of a solid phase containing the synthesized borazane (mainly with the co-product(s) synthesized in parallel (and also the remainder of the at least one ammonium salt used in excess but, in principle, without borohydride(s)); 2) said synthesized borazane precipitated from said generated solid phase is selectively dissolved in a solvent and 3) said (selectively) dissolved synthesized borazane is recovered by removing said solvent (by evaporation under vacuum). The selective dissolution requires a solvent for borazane, which is a non-solvent for the co-product(s) of the synthesis (it is understood that the co-product is sodium carbonate when sodium borohydride and ammonium carbonate are used as reagents and that co-products are generally generated when at least two ammonium salts and/or at least two borohydrides are used as reagents) and for the remainder of the at least one ammonium salt. Such a solvent may especially consist of tetrahydrofuran, 2-methyltetrahydrofuran, dioxane, acetonitrile, ethyl acetate, isopropyl acetate, dimethyl carbonate, or a mixture thereof.

Under the conditions (recalled above: reaction completed (any feed of gaseous ammonia obviously being stopped (i.e. the flushing with gaseous ammonia being stopped) and started with an excess of the at least one ammonium salt), for the recovery of the synthesized borazane, it is possible, according to a second variant, to proceed as follows: 1) the reaction medium is filtered to remove therefrom the solids (mainly the co-product(s) of the synthesis and the remainder of the at least one ammonium salt used in excess); and 2) the ammonia is removed (by evaporation, advantageously by evaporation under vacuum, with reference to the kinetics); said ammonia removal causing the precipitation of a solid phase constituted virtually exclusively (or even exclusively) of the synthesized borazane (in the absence, in principle, of any remainder of borohydride(s)).

It is thus possible to recover (a maximum amount of) the synthesized borane; said synthesized borane recovered having a very advantageous degree of purity.

It is clearly possible, in the context of the present invention, to perform the synthesis of borazane and the recovery thereof under less advantageous conditions (synthesis without excess of the at least one ammonium salt and/or not performed to completion, such that the borazane must be recovered from a medium containing it and also containing the at least one unreacted borohydride (in “significant” amount)). The borazane recovery methods specified above may conveniently be performed, but it is understood that they lead to a combined recovery of said synthesized borazane and of the at least one unreacted borohydride (in “significant” amount). It is then necessary, to obtain a “pure” borazane, to perform an additional step of borazane/borohydride(s) separation. Suitable methods, which are, however, generally difficult to industrialize, exist (for example sublimation). In any case, an additional step must be performed. It is understood that the implementation of the borazane synthesis under the advantageous conditions specified above (with an excess (preferably a slight excess) of the at least one ammonium salt and up to the depletion of the at least one borohydride (to its completion)) is thus strongly recommended.

According to a particularly preferred variant, the method of the invention comprises:
making a pulverulent mixture of at least one ammonium salt with at least one borohydride (of adequate type, see above)); the at least one ammonium salt being used in slight excess (less than 1%) relative to the stoichiometry;
flushing with gaseous ammonia to bring said mixture into contact with gaseous ammonia; and then, on conclusion of the reaction,
stopping the flushing with gaseous ammonia,
removing the ammonia, preferably by evaporation under vacuum; said ammonia removal generating a solid phase containing the synthesized borazane; and
selectively dissolving said synthesized borazane in a solvent and then removing said solvent, by evaporation under vacuum, to recover said synthesized borazane.

It is proposed below to illustrate the invention with an example. On consideration of said example, the great advantage of the method of the invention is confirmed.

### EXAMPLE

The metathesis reaction was performed in a three-necked round-bottomed flask (with a volume of 100 mL), equipped with stirring means.

The following were placed in said three-necked round-bottomed flask:
2.3 g of sodium borohydride (NaBH₄), and
2.9 g of ammonium carbonate ((NH₄)₂CO₃),
   in powder form (said ammonium carbonate was thus introduced in slight excess relative to the stoichiometry).

An ice bath was placed under said three-necked round-bottomed flask to ensure a temperature of 0° C. in the volume of said three-necked round-bottomed flask.

A stream of gaseous ammonia (about 45 mL/min) was then introduced, via one of the necks of the flask, at atmospheric pressure. The gaseous ammonia introduced, which was not liquefied, was removed via another of the necks of the flask.

From the moment of introduction of the stream of gaseous ammonia, the appearance of a heterogeneous reaction medium with a very large solid content was observed in the flask. Said heterogeneous medium (solid ((NH₄)₂CO₃)/liquid (co-liquefied sodium borohydride and ammonia) had a volume of about 5 mL. The reaction (solid ((NH₄)₂CO₃)/liquid (liquefied sodium borohydride) was performed in such a heterogeneous medium (of foamy white appearance (foamy due to the formation of hydrogen). It is recalled that the successive steps of co-liquefaction and of metathesis reaction are represented schematically as follows:

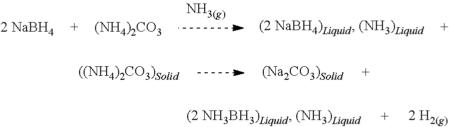

The reaction was continued for 3 hours while flushing with a stream of gaseous ammonia and with stirring.

On conclusion of these 3 hours (the inventors checked that the sodium borohydride (the starting 2.3 g) was then consumed), the feeding with gaseous ammonia was stopped. The flask was then degassed under vacuum. Its content once again became solid (powder).

The borazane thus synthesized was then recovered by selective dissolution, from said solid (from said powder).

2-Methyltetrahydrofuran (50 mL) was introduced, into said flask, onto the solid. Said 2-methyltetrahydrofuran ensured selective dissolution of the borazane; this resulted in the production of a solid phase dispersed in a liquid phase containing said borazane dissolved in said 2-methyltetrahydrofuran. This solid phase—constituted essentially of the product obtained together with the borazane (co-product: Na₂CO₃) and of the excess (NH₄)₂CO₃, predominantly of said product obtained together with the borazane (co-product: Na₂CO₃)—was removed by filtration.

The synthesized borazane, dissolved in the 2-methyltetrahydrofuran, was then recovered by evaporation of said 2-methyltetrahydrofuran (evaporation performed at 30° C., under 100 mbar for 1 hour).

1.3 g of borazane (NH₃BH₃) were thus recovered. This corresponds to a synthesis yield of 70% and to a synthesis productivity of close to 260 g of NH₃BH₃/L of reaction medium (the volume of the reaction medium (about 5 mL (see above), comprising 2.3 g of NaBH₄, 2.9 g of (NH₄)₂CO₃ and the liquefied NH₃ (8.1 L)) has been likened here to the volume of solvent (see the above definition of the synthetic productivity). The indicated value of 260 g/L (1.3/5×10³) is thus in fact lowered). Given that for a metathesis reaction performed “conventionally” by the Applicant (on a pilot scale) in organic solvent (2-methyltetrahydro-furan), the synthetic productivity is only about 26 g of NH₃BH₃/L of solvent (1.13 kg of NH₃BH₃ are obtained with 44 L of solvent (such an amount of solvent being necessary to selectively dissolve the synthesized borazane (the co-product obtained (Na₂CO₃) remaining insoluble)), the value of the synthesis according to the invention (implementation under gaseous ammonia, without solvent, under “mild” temperature and pressure conditions) is thus appreciated.

The borazane synthesized according to the invention moreover had an advantageous degree of purity. Specifically, the presence of impurities at detectable levels was not demonstrated either by ¹H NMR (a given mass of the synthesized borazane was dissolved in a solvent (THF); benzene being added to the analyzed solution as standard), or by infrared, i.e. any impurity potentially present was present only in a content of less than 1 wt. % (in point of fact, according to the infrared technique, any impurity potentially present was only present in a content very much less than 1 wt. %).

1. A method for producing borazane, comprising the synthesis of said borazane by reaction of at least one ammonium salt with at least one borohydride, said at least one borohydride being chosen from alkali metal borohydrides and alkaline-earth metal borohydrides, wherein said reaction is performed while flushing with gaseous ammonia; gaseous ammonia being co-liquefied with said at least one borohydride and gradually with borazane as said borazane is synthesized.

2. The method as claimed in claim 1, wherein said reaction is performed at a pressure of between 1×10⁵ and 2×10⁵ Pa (1 and 2 atm) and at a temperature of between −5° C. and 25° C.

3. The method as claimed in claim 1, wherein said reaction is performed in the absence of organic solvent.

4. The method as claimed in claim 1, wherein the gaseous ammonia is used in a gaseous ammonia/at least one borohydride mole ratio of greater than 1.

5. The method as claimed in claim 1, wherein the at least one ammonium salt is used in excess relative to the stoichiometry.

6. The method as claimed in claim 1, wherein it comprises:
making a mixture of said at least one ammonium salt with said at least one borohydride;
flushing with gaseous ammonia to bring said mixture into contact with gaseous ammonia; gaseous ammonia then being co-liquefied with said at least one borohydride; and
reacting said at least one co-liquefied borohydride and said at least one ammonium salt while flushing with gaseous ammonia; the synthesized borazane being co-liquefied with gaseous ammonia gradually as it is synthesized.

7. The method as claimed in claim 1, further comprising:
flushing with gaseous ammonia to bring said at least one borohydride into contact with gaseous ammonia; gaseous ammonia being co-liquefied with said at least one borohydride;
adding, to said at least one borohydride co-liquefied with gaseous ammonia, said at least one ammonium salt; and
reacting said at least one co-liquefied borohydride and said at least one ammonium salt, while flushing with gaseous ammonia; the synthesized borazane being co-liquefied with gaseous ammonia gradually as it is synthesized.

8. The method as claimed in claim 1, wherein said at least one ammonium salt is selected from ammonium carbonate, ammonium bicarbonate, ammonium sulfate, ammonium chloride, ammonium fluoride, ammonium nitrate, ammonium acetate and ammonium formate; and/or said at least one borohydride is chosen from sodium borohydride, lithium borohydride and potassium borohydride.

9. The method as claimed in claim 6, further comprising, on conclusion of the reaction:
stopping the flushing with gaseous ammonia;
removing the ammonia; the ammonia removal causing the precipitation of a solid phase containing the synthesized borazane; and
selectively dissolving said synthesized borazane in a solvent and then removing, by evaporation under vacuum, said solvent for recovery of said synthesized borazane.

10. The method as claimed in claim 9, wherein said solvent is selected from tetrahydrofuran, 2-methyltetrahydrofuran, dioxane, acetonitrile, ethyl acetate, isopropyl acetate and dimethyl carbonate, and a mixture thereof.

11. The method as claimed in claim 6, further comprising, on conclusion of the reaction:
stopping the flushing with gaseous ammonia;
filtering the reaction medium to remove the solids;
removing the ammonia; the ammonia removal causing the precipitation of a solid phase constituted virtually exclusively of said synthesized borazane.

12. The method as claimed in claim 1, further comprising:
making a pulverulent mixture of said at least one ammonium salt with said at least one borohydride; the at least one ammonium salt being used in slight excess, relative to the stoichiometry;
flushing with gaseous ammonia to bring said mixture into contact with gaseous ammonia; and then, on conclusion of the reaction,
stopping the flushing with gaseous ammonia;
removing the ammonia; said ammonia removal generating a solid phase containing the synthesized borazane; and
selectively dissolving said synthesized borazane in a solvent and then removing, by evaporation under vacuum, said solvent for the recovery of said synthesized borazane.

13. The method as claimed in claim 2, wherein said reaction is performed at atmospheric pressure.

14. The method as claimed in claim 4, wherein the gaseous ammonia is used in a gaseous ammonia/at least one borohydride mole ratio greater than 5.

15. The method as claimed in claim 5, wherein the at least one ammonium salt is used in slight excess relative to the stoichiometry.

16. The method as claimed in claim 8, wherein said at least one ammonium salt consists of ammonium carbonate and/or said at least one borohydride consists of sodium borohydride.

17. The method as claimed in claim 8, wherein said at least one ammonium salt consists of ammonium carbonate and said at least one borohydride consists of sodium borohydride.

18. The method as claimed in claim 9, wherein the ammonia is removed by evaporation under vacuum.

19. The method as claimed in claim 11, wherein the ammonia is removed by evaporation under vacuum.

20. The method as claimed in claim 12, wherein the ammonia is removed by evaporation under vacuum.
